(19) United States
(12) Patent Application Publication
(10) Pub. No.: US 2012/0267503 A1
(43) Pub. Date: Oct. 25, 2012

(54) Self-leveling, gravity-stabilized, sliding and tilting support for a chair

(76) Inventor: James E. Gribble, (US)

(21) Appl. No.: 13/091,512

(22) Filed: Apr. 21, 2011

(51) Int. Cl. F16M 11/22

(52) U.S. Cl. 248/393

(57) ABSTRACT

The self-leveling, gravity-stabilized, sliding and tilting support for a chair is a gravity-powered human stabilization device for use on moving craft such as boats, ships, cars, trucks and aircraft. This device belongs to a family of human stabilization devices often referred to in the past as “gimbaled chairs.” Similarly purposed devices often known as “rolling chairs” also have been invented. The present invention performs the same function as gimbaled chairs and rolling chairs but is much smaller, lighter, simpler, cheaper to make; lacks spindles or gantries, axles, wheels, bearings or metallic tracks; needs no maintenance or lubrication; and has just one moving part. The basic device is constructed of just nine parts. These components are very simple; all can be readily, inexpensively fabricated using common composite construction techniques. At the heart of the device is a rotationally sliding payload platform. The platform is secured atop a semi-circular, upwardly curved dish. The outer edges of the dish ride inside radius-grooved, low-friction, high-density plastic end caps secured within a containment cassette. The dish/payload platform assembly rotationally slides freely and smoothly to remain level while the cassette and the mounting base tilt as the craft upon which the device is mounted rolls from side to side.

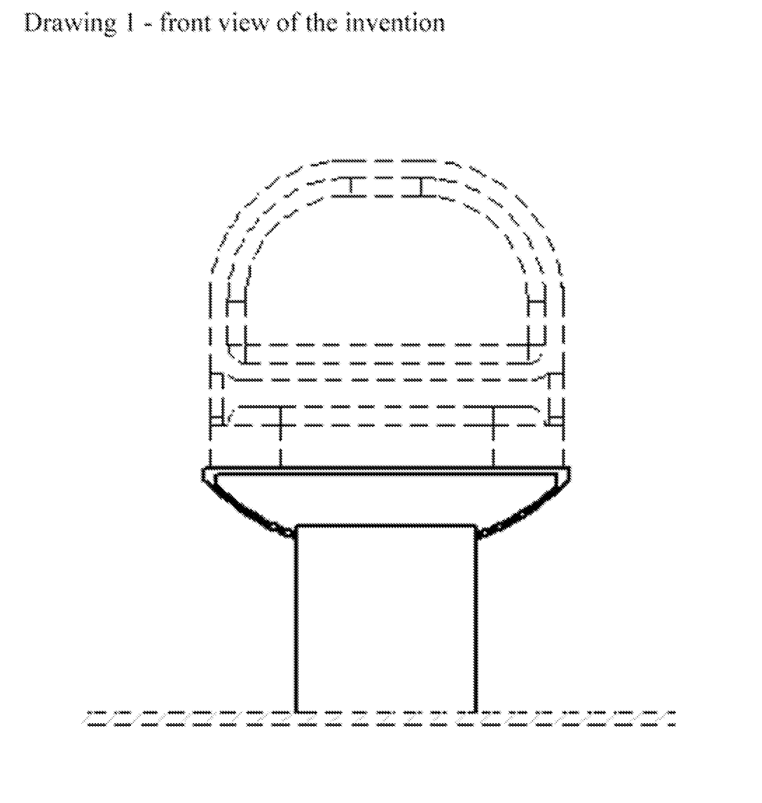

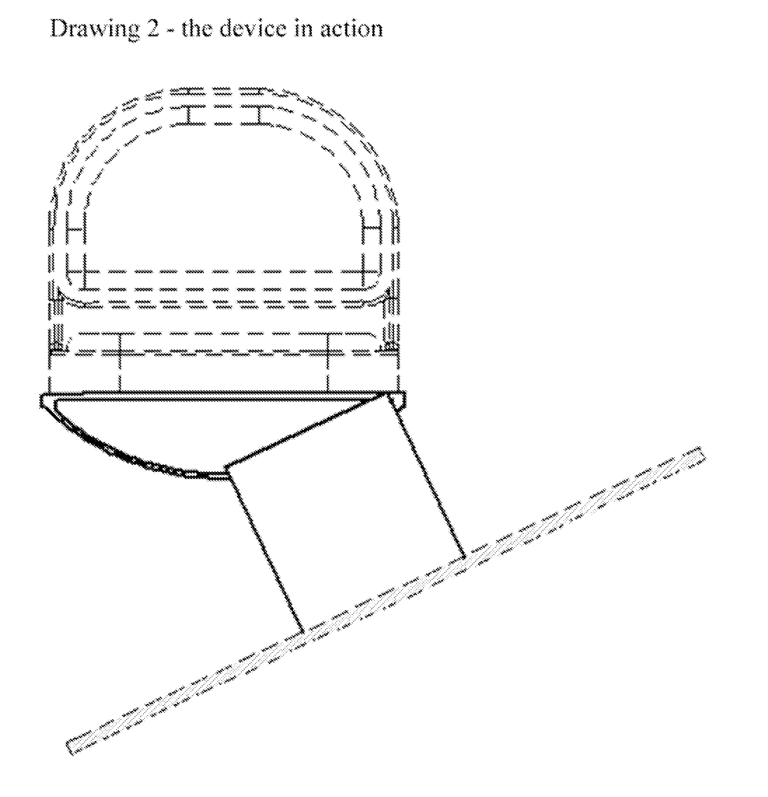

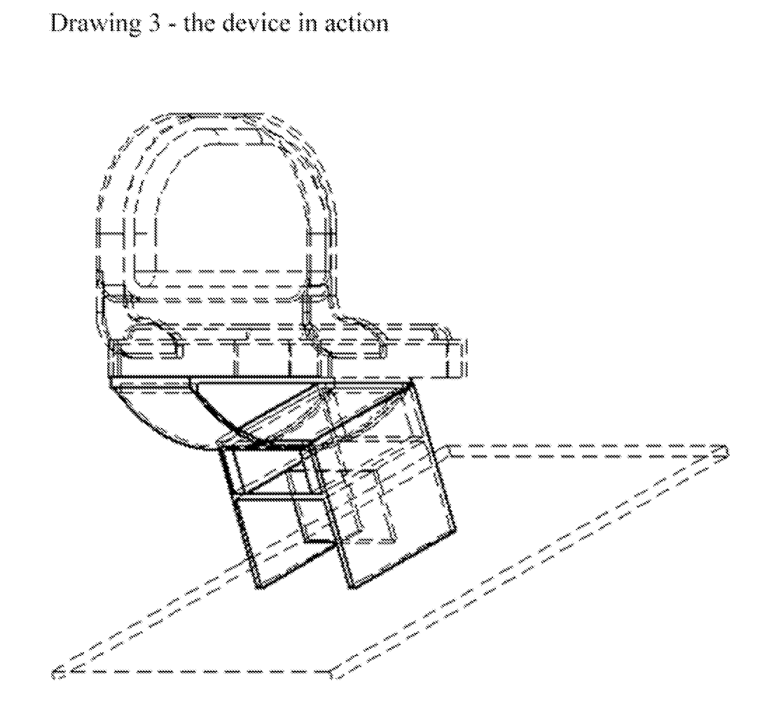

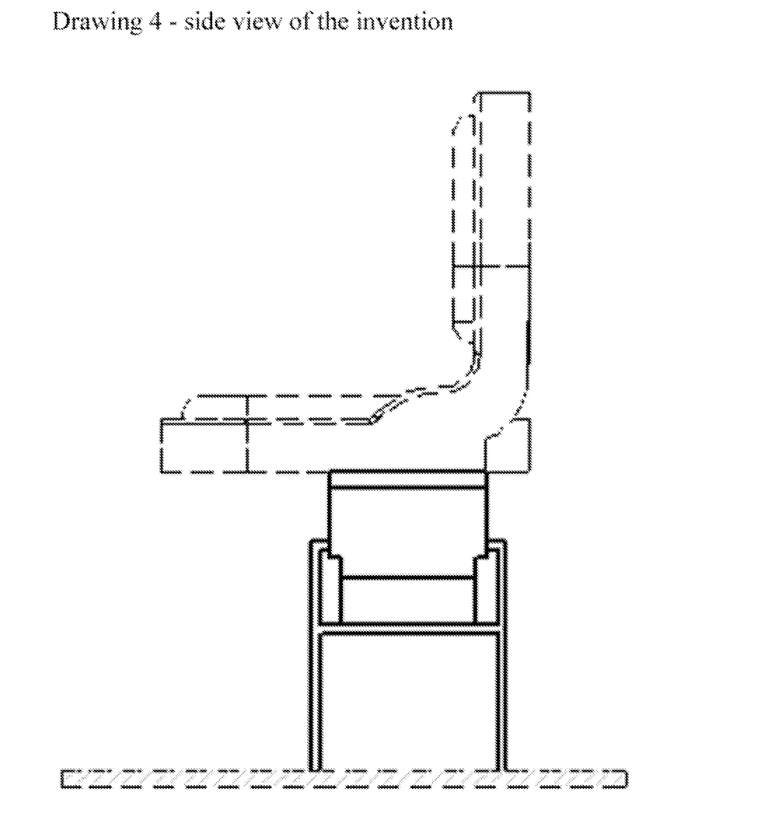

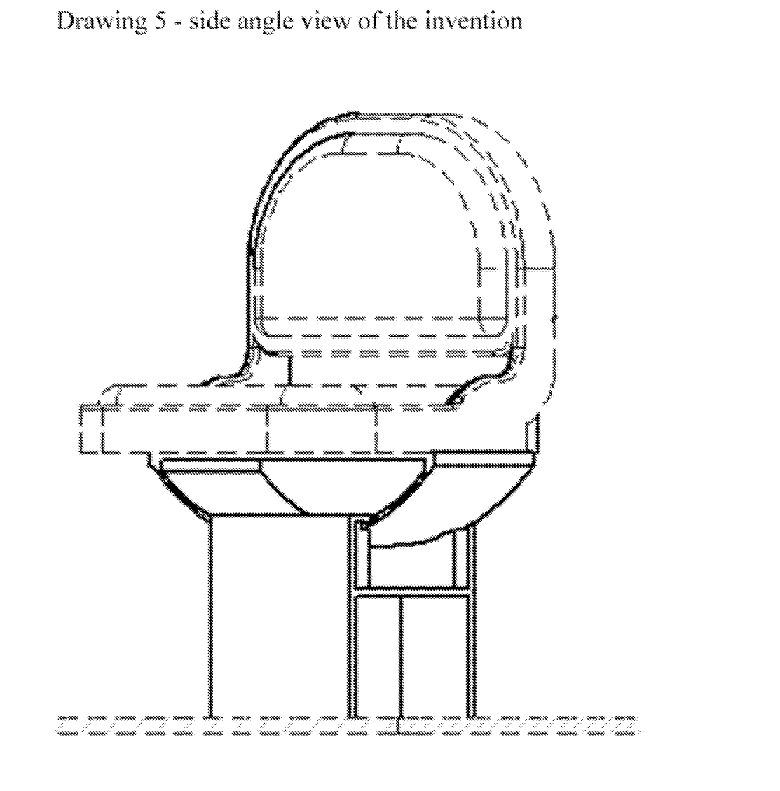

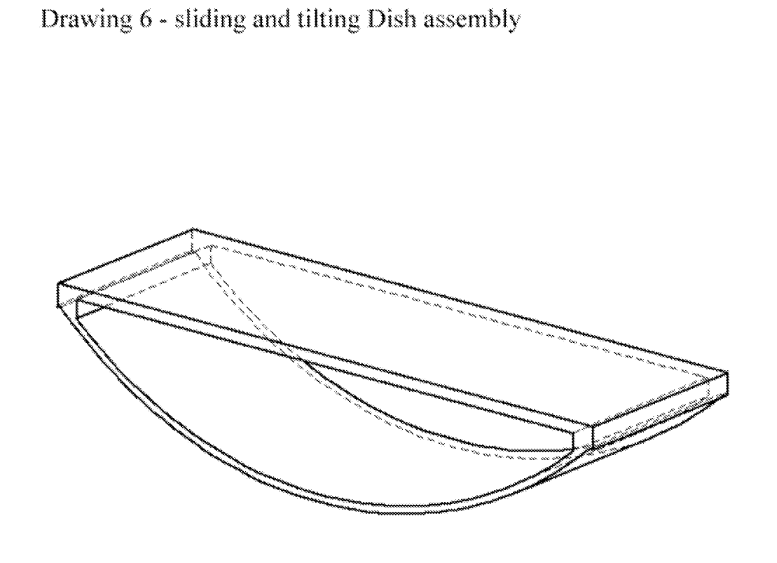

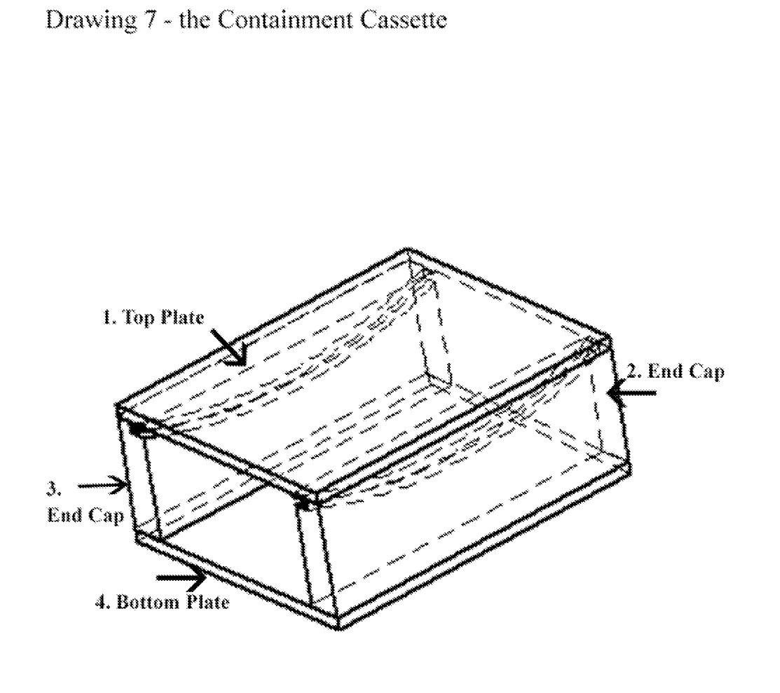

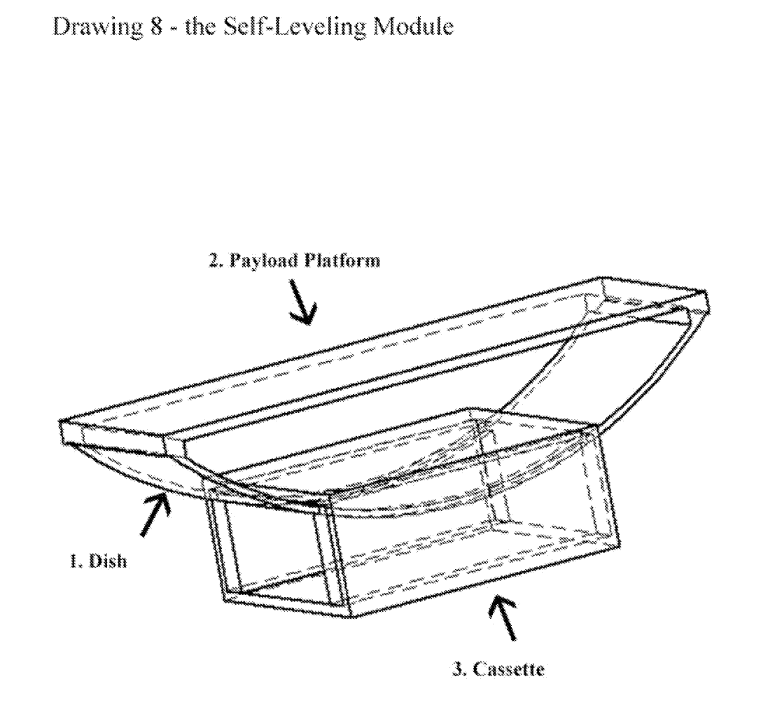

### SUMMARY OF THE INVENTION

All moving craft present physical challenges to their occupants. As it gets bounced around and changes direction, the craft tosses its crew to and fro. Launched this way and that, becoming in effect free projectiles, they waste precious energy in constantly bracing themselves with their feet, legs, arms and hands. As a remedy, devices such as the present invention attempt to provide a stable micro-environment. One goal is to reduce fatigue; another is to allow accomplishment of especially complicated tasks. People find it not just tiring, but frustrating, to tackle intricate jobs when the craft is bouncing around. They need use of both hands. It is simply unworkable to have one hand tied up by the chore of hanging on for one's dear life.

Setting my invention apart from the prior art is the fact that it contains only one moving part. The device is for use on moving craft of all types—sea, land and air—in applications which in their totality call for simplicity, compact size, high strength, light weight, ease of maintenance, rugged durability and extreme reliability. Racing yachts and aircraft are good examples of such applications. Potential uses for the invention will include navigation, systems control and piloting. The invention allows a seated occupant to remain upright while the craft tips. On a sailboat, sideways tipping from the horizontal plane is known as “heeling.” On an aircraft it is called “banking” On a vehicle it is called “leaning” For consistency sake in this application, “roll” will be the all-encompassing descriptor for these phenomena.

Craft tend to be less stable laterally (“athwart-ship”). Therefore, rolling more than pitching (fore-and-aft rocking) is the most persistent motion challenge. Although the present invention is primarily envisioned as being used to motion-compensate for roll, it can be alternatively oriented to motion-compensate for the effects of pitch. In roll-compensation mode, the sliding-and tilting mechanism is oriented transverse to the longitudinal axis of the craft. This would be more appropriate to a heeling sailboat or a banking aircraft or a high-speed motorboat making sharp turns on a race course. In pitch-compensation mode, the sliding-and-tilting mechanism is oriented parallel to the centerline of the craft (“amid-ship”). This would be more appropriate to an ocean-going vessel journeying through high, plunging seas. It is anticipated that the invention could be mounted on top of a base which rotates around its vertical axis, such that its motion-stabilization function could be oriented in any direction. All prior attempts at making a device similar to mine have suffered from the same basic drawbacks: they were large, heavy, intricately engineered, complicated, expensive to manufacture and had many moving parts which were individually subject to failure.

ONE OBJECT of the present invention is to create a support for a chair which, when a person sits atop of it, remains level to the force of gravity (self-leveling) while the craft upon which the invention is mounted tilts horizontally.

ANOTHER OBJECT of the present invention is to provide a self-leveling support for a chair that is very simple to make, at low cost, thanks to an elegantly simple solution to the problem of motion compensation; and thanks to being made out of simple flat sheets, which can readily be composite materials.

ANOTHER OBJECT of the present invention is to provide a self-leveling support for a chair that is very compact and light, thanks to its unique inverted-arch technology; and thanks to its unique suitability for composite construction.

ANOTHER OBJECT of the present invention is to provide a self-leveling support for a chair that is yet very strong, again thanks its unique inverted-arch technology; and again thanks to its unique suitability for composite construction.

ANOTHER OBJECT of the present invention is to provide a self-leveling support for a chair that is very easy and comfortable to use, by virtue of its compact base and adaptability to any kind of seat or chair.

ANOTHER OBJECT of the present invention is to provide a self-leveling support for a chair that is very easy to maintain and repair, by virtue of being relatively small and expressly designed for easy disassembly.

ANOTHER OBJECT of the present invention is to provide a self-leveling support for a chair which is so small and light that it can be used as a temporary, highly portable piece of gear; that is, readily capable of being installed and uninstalled as needed.

ANOTHER OBJECT of the present invention is to provide a self-leveling support for a chair that is very durable, again thanks to being readily made from composite materials; and thanks to its innovative simplicity.

ANOTHER OBJECT of the present invention is to provide a self-leveling support for a chair that is very reliable, thanks to its innovative simplicity.

ANOTHER OBJECT of the present invention it to provide a self-leveling support for a chair that remedies the many drawbacks found in the related prior art.

### DETAILED DESCRIPTION OF THE INVENTION

One of the earliest motion-stabilization inventions, aimed at minimizing fatigue, was the seaman's hammock. Still in use today, it allows crew to sleep while their ship rolls upon the ocean waves. Later were developed mechanically suspended, pendulum-based swinging chairs, commonly referred to as “gimbaled.” A second type, more numerous recently, is the “rolling chair,” in which a chair mounted on wheels rolls upon a frame of upwardly curved rails.

My self-leveling, gravity-stabilized, sliding-and-tilting support for a chair acts like a gimbaled chair in that it gravity-stabilizes the occupant; and yet it is not gimbaled, lacking any spindles, frames or gantries. Neither is it a rolling chair, lacking rails or wheels. It features a payload platform upon which any type of seat or chair can be replaceably installed. The platform mounts on top of an upward-curved dish. The dish is constructed of laminated thin sheets. Said dish slides rotationally within two grooved end caps of a containment cassette. The end caps are made of a low-friction, high-density polyethylene plastic. The weight of a person sitting atop the device naturally forces the platform to attain horizontal orientation—level to the force of gravity. This gravity-powered tilting and sliding occurs effortlessly despite the lack of bearings, wheels or rollers. The seated user has both hands free to do whatever kind of intricate task is required. Freed from the grinding burden of having to physically brace him or her self, the user also conserves precious energy.

The laminated construction of the dish robustly endows it with innate strength and shape-holding ability. Then, when the dish is mated to the payload platform, the resulting assembly has the engineering properties of a cross-braced inverted arch. Thus endowed with enormous rigidity, the assembly becomes highly resistant to torque which would be caused by the occupant sitting far forward or far backward in the chair; such that the dish will not distort and bind; and can be made very thin and light; and its radius can be very small; yet still allowing it to motion-compensate for extreme angles of roll. There will be little need for maintenance. However, should such become necessary, the cassette can be easily disassembled and the end caps replaced. Furthermore, this can be done at very low cost because the parts are very simple.

Simplicity constitutes a core attribute of my claim. As a thing becomes more complex, it becomes more difficult to make. The difficulty of making drives up the cost to the end user. Unless that cost can be kept below a price that a free-market customer would consent to pay, the thing lacks any practical commercial value. This has been the big drawback of preceding human stabilization devices. Many earlier inventors have claimed that their devices were simple to make. I believe this one really has the potential to become a commercial product. I have built a prototype and tested it rigorously in trials at sea on a sailboat.

The present invention has only one moving part. The sliding-and-tilting, self-leveling mechanism contains just six simple parts. Exclusive of miscellaneous fasteners and mounting hardware, the entire invention contains just nine parts. Said parts may be glued or mechanically fastened together. The practical making of relevant prior inventions involved complex metal forming, machining and welding, whereas I built my prototype with common tools and simple jigs and clamps. Different from prior relevant devices, the practical making of the present invention need not be essentially from extruded, bent, formed and welded steel. Its major parts can readily be made out of non-corroding, polymer-based composite materials.

“Readily made” here is defined as meaning commercially practical. It is true that almost anything can be made out of composites. However, the cost of manufacturing increases as the complexity of the parts increases. This drives up the cost/benefit ratio, such that the product cannot be offered for sale at an attractive price; it becomes impractical to make commercially. The present invention squarely addresses that problem. To facilitate cost-effective composite construction, it is designed to be built entirely from flat-sheet materials, versus complex tubing. These materials could include:
Fiberglass-reinforced plastic
Carbon fiber-reinforced plastic
Kevlar-reinforced plastic

But, for construction purposes, almost any other flat, strong, rigid material, from the commonplace to the exotic, also will suffice, including for example:
Wood veneers
Plywood
Plastic
Fabrication could also utilize flat-sheet materials yet to be invented, yet to be imagined.
None of the major parts need be made of metal, although they can be made of metal if desired.
Even if most of it major parts were made of metal, the present invention still would be significantly lighter than relevant devices of prior art, because it is so much more compact.

Relative to prior art, the present invention is significantly smaller, taking up four square feet of floor space. Being very small, in addition to not needing to be built substantially out of steel or other metals, the present invention is relatively, significantly, intrinsically lighter. It can be built in at time of craft construction or easily retrofitted to existing craft. The small size and light weight of the design facilitates temporary mounting, allowing the device to be used as a piece of occasional gear (installed or removed as needed).

Being a chair support, it is readily customizable to individual owner preference, enhancing comfort. The owner will install, or have installed, his or her seat or chair of choice; dozens of different models and styles are sold commercially. The present invention, lacking any complex suspension frame, also is far more relatively easy to use. Because the invention sits completely beneath the chair, with no protruding parts to any side, a person can get into and out of the chair with complete ease. The person can sit down or exit from either side or from the front. Seated upon the chair, the user will have complete freedom of upper-body movement; and both of the person's hands will be available for complicated, high-precision tasks.

The present invention is easily accessorized for purposes beyond simply stabilizing the sitter. Hand controls, such as joy sticks or yokes, may be fitted to the payload platform. By means of a pedestal desk affixed to the front of the payload platform, the device can mount a wide array of computer devices, digital instrumentation and, even, operating controls; thereby functioning as a compact, gravity-stabilized, integrated, unitized, electronic work station. Even further, the device may be accessorized by mounting a foot-rest pedestal to the payload platform. Even further, the basic design may be applied to other purposes aside from supporting a chair; the basic design is applicable to any need for a self-leveing support; or for mounting a device or apparatus, rather than a chair and a person.

In the totality of its contrivance, compared to relevant devices of prior art, the present invention is completely different. In terms of simplicity, size, weight, strength, ease of maintenance and repair, durability and reliability, it represents a tangible advance. I installed the prototype on a sailboat and subjected it to rigorous sea trials. The working prototype directly inspired the drawings in this application.

### FEDERALLY SPONSORED RESEARCH AND DEVELOPMENT

This invention was not made with the aid of federal research and development fund.

### BACKGROUND OF THE INVENTION

While using familiar forms and concepts, the present invention harnesses them in a new way which is nonobvious. I have studied the past art in order to assure myself that the invention meets the critical tests for the issuance of a patent. Nothing like it exists, to my knowledge. Acknowledging that my understanding may not be definitive and perfect, I will explain what I see as the tangible differences between the present invention and the prior art.

Many prior devices have been invented to gravity-stabilize crew and passengers of moving craft such as sailboats and airplanes. Said devices appear to fall into two general categories:
a. Gimbaled chairs, in which a hanging chair swings from an armature or frame (gantry) on one or more spindles.
b. Rolling chairs, in which a wheeled platform or integrated chair rolls sideways on top of an upward-curved frame.

### 1) Compared to Gimbaled-Chair Devices

Examples of previously patented gimbaled-chair devices are:
The “oscillating chair” of Thomas, U.S. Pat. No. 12,703, April 1855. (This design is a hybrid, also incorporating a rolling chair).
The “swinging chair” of Reed, U.S. Pat. No. 968,195, August 1910.
The “self-leveling and swiveling chair” of Bosnich, U.S. Pat. No. 3,863,587, February 1975.
The “stabilized oscillating chair” of Kelley, U.S. Pat. No. 4,254,990, March 1981.
The “pendulum helmsman seat” of Cutler, U.S. Pat. No. 4,425,863, January 1984.
The “boat seat stabilizing apparatus” of Martinez et al, U.S. Pat. No. 5,119,754, June 1992.
COMPARING RELATIVE SIMPLICITY—Gimbaled-chair devices have many complex features which render them complicated to build. Their basic concept requires some form of suspension frame from which the chair and its ancillary apparatus are hung by means of a spindle in order that they may swing freely to the force of gravity like a pendulum. When such frame takes the form of a single gantry, the cantilever forces upon the gantry require it to be highly engineered. The same cantilever forces will require the gantry to have a very robust support, which again requires it to be highly engineered. Cantilever loads, again, require the chair and its mounting spindle to be highly engineered. The sheer number of necessary parts, and their intrinsically complex design, causes gimbaled-chair devices to be relatively quite complicated. The afore-stated relative drawbacks exist in all gimbaled-chair devices of prior art.
THEIR MOST VIVID EMBODIMENT is the “swinging chair of Reed,” U.S. Pat. No. 968,195, which features a central gantry, several support frames and multiple spindles, endowing it with relative complexity.
FURTHER INSTRUCTIVE is the “boat seat stabilizing apparatus” of Martinez et al, U.S. Pat. No. 12,703, which features a complicated base, three massive gantries and two large spindles, again endowing the device with relative overall complexity.
FOR YET ANOTHER EXAMPLE, the “self-leveling and swiveling chair” of Bosnich, U.S. Pat. No. 3,863,587, features a complicated base, cantilevered support frame and counterweighted central spindle, again endowing the device with relative overall complexity. This device moreover is more properly classified as an adjustable chair, in that it apparently is not designed to continually gravity-stabilize the user. It therefore possesses tangibly less usefulness than the present invention.
FOR YET ANOTHER EXAMPLE, the “pendulum helmsman seat” of Cutler, U.S. Pat. No. 4,425,863, features a large, complicated base and gantry and a massive spindle from which hangs a cantilevered chair, again endowing the device with relative overall complexity.
FOR YET ANOTHER EXAMPLE, the “oscillating chair” of Thomas, U.S. Pat. No. 12,703, features a pitch-compensating gimbaled chair hung from two large spindles inside a massive U-shaped support pedestal, again endowing the device with relative overall complexity.
FOR YET ANOTHER EXAMPLE, even the lightest and mechanically simplest of these gimbaled-chair devices, the “stabilized oscillating chair” of Kelley, U.S. Pat. No. 4,254,990, features a complicated suspension frame and base, again endowing the device with relative overall complexity.
IN CONTRAST TO the aforementioned examples of prior art, the present invention has just nine basic parts, all of which can easily be built from a wide array of flat-sheet materials, using no special tools. The present invention is far less complex to make. Construction can readily be almost completely non-metallic, requiring no metal forming or welding. Gimbaled-chair devices of art which have preceded the present invention are so elaborate that none are being manufactured currently, to my knowledge.
b. COMPARING RELATIVE SIZE—The suspension frame and base of a gimbaled-chair device are spatially intrusive, taking up excessive room. These bulky parts will extend out to the sides and to the rear, and in some cases even in front of the chair. The afore-stated relative drawbacks exist in all gimbaled-chair devices of prior art.
   THEIR MOST VIVID EMBODIMENT is the “boat seat stabilizing apparatus” of Martinez et al, U.S. Pat. No. 12,703, which features a massive flat steel base, two massive, tubular-steel gantries and two massive spindles, all of which encroach relatively substantially upon adjacent space.
   FOR YET ANOTHER EXAMPLE, the “self-leveling and swiveling chair” of Bosnich, U.S. Pat. No. 3,863,587, features a three-member tubular base which extends to the rear and to the sides, again encroaching relatively substantially upon adjacent space.
   FOR YET ANOTHER EXAMPLE, the “pendulum helmsman seat” of Cutler, U.S. Pat. No. 4,425,863, features a massive, tubular-steel gantry behind the seat, again encroaching relatively substantially upon adjacent space.
   FOR YET ANOTHER EXAMPLE, the “stabilized oscillating chair” of Kelley, U.S. Pat. No. 4,254,990, features a wide base which extends well to the rear of the device, again encroaching relatively substantially upon adjacent space.
   FOR YET ANOTHER EXAMPLE, the ring frames of the “swinging chair of Reed,” U.S. Pat. No. 968,195, extend outward in three directions, again encroaching relatively substantially upon adjacent space.
   IN CONTRAST TO the aforementioned prior art, the present invention fits neatly under a standard seat, no encroachment at all to the front or to the rear; the sole clearance needed will be a modest allowance to the sides to allow for the tilting of the payload platform. Compared to gimbaled-chair devices, it possesses a small footprint and can be installed in very tight spaces.
c. COMPARING RELATIVE WEIGHT—As noted above in (1, a), the basic concept of a gimbaled-chair device requires a suspension frame and spindles. When such frame takes the form of a single gantry, the intrinsic requirement that the gantry be highly engineered also causes it to be extremely heavy. The same cantilever forces will require the gantry to have a wide, heavy base, in order to secure the device from tipping over. Because the gantry will tilt as the craft tilts, its inherently heavy weight will transmit added cantilever loads to the base of the appliance.
   Cantilever loads, again, will require the chair and its mounting spindle to be extremely strong and extremely heavy. Adding further to its intrinsic weight, the frame also must be high, such that the suspension point (or points) is well above the vertical center of gravity of the chair and the occupant. Any cantilevered structure will place tremendous levering stress on its base, which in turn will be transferred directly to the floor. This requires the floor and its substructure to be immensely strong. The afore-stated relative drawbacks appear in all gimbaled-chair devices of prior art.
   THEIR MOST VIVID EMBODIMENT is the “boat seat stabilizing apparatus” of Martinez et al, U.S. Pat. No. 12,703, which features a massive flat base, two massive, tubular gantries and two massive spindles, all of which vastly endow the device with relative overall heaviness.
   FURTHER INSTRUCTIVE is the “pendulum helmsman seat” of Cutler, U.S. Pat. No. 4,425,863, which features a massive base, a massive tubular gantry and a massive spindle from which hangs a cantilevered chair, again richly endowing the device with relative overall heaviness.
   FOR YET ANOTHER EXAMPLE, the “self-leveling and swiveling chair” of Bosnich, U.S. Pat. No. 3,863,587, features a massive cantilevered support frame. Here we see an attempt to overcome the height requirement for a gantry, in that the chair is positioned on top of the pendulum. But with the chair and the weight of the person no longer positioned at the bottom of the pendulum, so to speak, the pendulum itself must be stabilized by means of large and heavy counterweights. The afore-stated drawbacks again richly endow the device with relative overall heaviness.
   FOR YET ANOTHER EXAMPLE, the “oscillating chair” of Thomas, U.S. Pat. No. 12,703, features a large, pitch-compensating gimbaled chair hung inside a massive U-shaped support pedestal, again endowing the device with relative overall heaviness.
   FOR YET ANOTHER EXAMPLE, even the lightest and mechanically simplest of these gimbaled-chair devices, the “stabilized oscillating chair” of Kelley, U.S. Pat. No. 4,254,990, features a substantial tubular frame and base, again endowing the device with relative overall heaviness.
   IN CONTRAST TO the aforementioned examples of prior art, the present invention needs no suspension frame. A simple box-style base sits beneath the chair. The chair's weight and that of the occupant exert themselves downward. Not having to cope with extreme cantilever forces, the base can be made light and compact. The sliding-and-tilting-dish mechanism considerably lowers overall weight through its innovative use of inverted-arch technology. The sheer small size of the present invention contributes to its relative lightness. Also unlike gimbaled-chair devices of prior art, the present invention can be readily made from lightweight composite materials.
   “Readily made” here is defined as meaning commercially practical. As stated above in the Preamble, almost anything can be made out of composites. However, the cost of manufacturing increases as the complexity of the parts increases. This drives up the cost/benefit ratio, such that the product cannot be offered for sale at an attractive price. The present invention squarely addresses that problem. To facilitate cost-effective composite construction, it is designed to be built entirely and economically from flat-sheet materials, versus the complex tubes found at the core of gimbaled-chair devices.
d. COMPARING RELATIVE EASE OF USE—By their nature, gimbaled-chair devices employ bothersome suspension pedestals and gantries which render it difficult for a person to get into or out of the chair. Once a person is seated, said appendages inhibit freedom of movement. The afore-stated relative drawbacks exist in most gimbaled-chair devices of prior art.
   THEIR MOST VIVID EMBODIMENT is the “swinging chair” of Reed, U.S. Pat. No. 968,195, in which a system of elaborate, elbow-high, ring-style suspension frames awkwardly surrounds the sitter on three sides, diminishing relative ease of use.
   FOR YET ANOTHER EXAMPLE, in the “stabilized oscillating chair” of Kelley, U.S. Pat. No. 4,254,990, two near-shoulder-height spindles awkwardly flank the sitter, again diminishing relative ease of use.
   FOR YET ANOTHER EXAMPLE, the “boat seat stabilizing apparatus” of Martinez et al, U.S. Pat. No. 12,703, awkwardly positions the sitter next to a massive, shoulder-high gantry and spindle, yet again diminishing relative ease of use.
   FOR YET ANOTHER EXAMPLE, the “oscillating chair” of Thomas, U.S. Pat. No. 12,703, features a massive U-shaped support pedestal, the top spindles of which awkwardly flank the sitter at near shoulder height, still yet again diminishing relative ease of use.
   IN CONTRAST TO the aforementioned examples of prior art, the present invention, lacking any complex suspension frame, is far easier to use. Because the invention sits completely beneath the chair, with no upper appendages whatsoever, a person can get into and out of the chair with complete ease. The person can sit down or exit from either side or from the front. Seated upon the chair, a user has complete freedom of upper-body movement.
e. COMPARING RELATIVE COMFORT—All gimbaled-chair devices of prior art have built-in chairs which cannot be modified, changed or customized for the preference and comfort of individual owners.
   FOR EXAMPLE, the “swinging chair” of Reed, U.S. Pat. No. 968,195, features a permanent, integral chair which cannot be substituted or substantially changed, detracting from relative comfort.
   FOR YET ANOTHER EXAMPLE, the “oscillating chair” of Thomas, U.S. Pat. No. 12,703, features a permanent, integral chair which cannot be substituted or substantially changed, yet again detracting from relative comfort.
   FOR YET ANOTHER EXAMPLE, the “stabilized oscillating chair” of Kelley, U.S. Pat. No. 4,254,990, features a permanent, integral chair which cannot be substituted or substantially changed, still yet again detracting from relative comfort.
   FOR YET ANOTHER EXAMPLE, the “pendulum helmsman seat” of Cutler, U.S. Pat. No. 4,425,863, features a permanent, integral chair which cannot be substituted or substantially changed, yet once again detracting from relative comfort.
   FOR YET ANOTHER EXAMPLE, the “boat seat stabilizing apparatus” of Martinez et al, U.S. Pat. No. 5,119,754, features a permanent, integral chair which cannot be substituted or substantially changed, yet again detracting from relative comfort.
   IN CONTRAST TO the aforementioned examples of prior art, the present invention is a seat support. The owner will install or have installed his or her seat or chair of choice; dozens of different models and styles are sold commercially. The present invention thus is readily customizable to individual taste and preference, greatly enhancing pleasure and comfort when compared to most gimbaled-chair devices of prior art.
f. COMPARING RELATIVE EASE OF MAINTENANCE AND REPAIR—The more complicated devices grow, the more difficult and expensive they become to repair. As stated above in (1, a), the concept of gimbaled-chair devices predicates an overall, inherent, relative complexity. The difficulty of taking apart the afore-referenced devices for maintenance or repair would be relatively extreme. The afore-stated drawbacks exist in all gimbaled-chair devices of prior art.
   THEIR MOST VIVID EMBODIMENT is the “swinging chair of Reed,” U.S. Pat. No. 968,195. With its gantry, support frames and multiple spindles, the aforesaid would be relatively problematic to disassemble for maintenance and repair.
   FURTHER INSTRUCTIVE is the “boat seat stabilizing apparatus” of Martinez et al, U.S. Pat. No. 12,703. Again, with its complicated base, three gantries and two massive spindles, the aforesaid would be very relatively problematic to disassemble for maintenance and repair.
   FOR YET ANOTHER EXAMPLE, the “self-leveling and swiveling chair” of Bosnich, U.S. Pat. No. 3,863,587, again would be relatively problematic to disassemble for maintenance and repair, as a consequence of its complicated base, gantry, massive spindle and cantilevered chair.
   FOR YET ANOTHER EXAMPLE, the “pendulum helmsman seat” of Cutler, U.S. Pat. No. 4,425,863, yet again would be relatively problematic to disassemble for maintenance and repair, as a consequence of its complicated base, gantry, massive spindle and its cantilevered chair.
   FOR YET ANOTHER EXAMPLE, the “oscillating chair” of Thomas, U.S. Pat. No. 12,703, yet again would be relatively problematic to disassemble for maintenance and repair, as a consequence of its complicated U-shaped support pedestal and spindles.
   FOR YET ANOTHER EXAMPLE, the “stabilized oscillating chair” of Kelley, U.S. Pat. No. 4,254,990, yet again would be relatively problematic to disassemble for maintenance and repair, as a consequence of its complicated suspension frame and base.
   IN CONTRAST TO the aforementioned devices of prior art, the critical parts of the present invention are designed to be easily taken apart. Scant likelihood exists of repair being needed. However, should such become necessary, the cassette can be easily disassembled and the end caps replaced. These parts need not be expensive because they are so simple. It would be quite practical to box up the cassette and ship it to a central service center. Furthermore, the small size of the entire unit allows the owner to readily un-install it and transport it home or to a repair shop for service.
g. COMPARING RELATIVE DURABILITY—The durability (working lifespan) of any manufactured device is closely related to its complexity. As stated above in (1, a), gimbaled-chair devices are inherently, relatively complicated. Witness the sheer number of parts that form their individual constructs; each part is subject to wear and tear; each part therefore multiply detracts from overall durability.
   durability. Furthermore, extensive use of rust-prone metals is intrinsic to the practical making of these devices. The afore-stated relative drawbacks appear in all gimbaled-chair devices of prior art.
   THEIR MOST VIVID EMBODIMENT is the “swinging chair of Reed,” U.S. Pat. No. 968,195. Said device exhibits a sheer, overall complexity which will detract from intrinsic durability.
   FURTHER INSTRUCTIVE is the “boat seat stabilizing apparatus” of Martinez et al, U.S. Pat. No. 12,703. Said device again exhibits a sheer, overall complexity which will detract from relative intrinsic durability.
   FOR YET ANOTHER EXAMPLE, the “self-leveling and swiveling chair” of Bosnich, U.S. Pat. No. 3,863,587, yet again exhibits a sheer, overall complexity which will detract from relative intrinsic durability.
   FOR YET ANOTHER EXAMPLE, the “pendulum helmsman seat” of Cutler, U.S. Pat. No. 4,425,863, again exhibits a sheer, overall complexity which will detract from relative intrinsic durability.
   FOR YET ANOTHER EXAMPLE, the “oscillating chair” of Thomas, U.S. Pat. No. 12,703, yet again exhibits a sheer, overall complexity which will detract from relative intrinsic durability.
   FOR YET ANOTHER EXAMPLE, even the lightest and mechanically simplest of these gimbaled-chair devices, the “stabilized oscillating chair” of Kelley, U.S. Pat. No. 4,254,990, even yet again exhibits a sheer, overall, relative complexity which will detract from relative intrinsic durability.
   IN CONTRAST TO the aforementioned examples of prior art, the present invention is far more likely to last in that there simply are a lot fewer things to go wrong. With only one moving part, and nine basic total parts, there are simply fewer things to wear out. Furthermore, the unique nature of its core technology, based on a braced inverted arch, endows the invention not just with strength, but enduring strength. Furthermore, the present invention can be readily made out of corrosion-proof composite materials; which will never wear out due to rust; especially in extreme and wet environments, such composite construction renders the present invention extremely hardy.
h. COMPARING RELATIVE RELIABILITY—Just like durability, the reliability (frequency and likelihood of breakdowns) of any manufactured item is closely related to its complexity. As stated above in (a), gimbaled-chair devices are inherently, relatively complicated. Again, witness the sheer number of parts that form their individual constructs; each part being individually subject to wear and tear; each part therefore multiply detracting from overall reliability. Furthermore, in a gimbaled-chair device, the weight of the swinging chair and its occupant are borne by spindles. And so the entire working load is focused intensely on one or two small parts. The intense load on said parts will create friction, in turn causing wear. Secondly, the intense high load on said parts increases the likelihood of breakage. The afore-stated relative drawbacks exist in all gimbaled-chair devices of prior art.
   THEIR MOST COMPELLING EMBODIMENT is the “swinging chair” of Reed, U.S. Pat. No. 968,195. Said device's complicated spindles and support frames will detract from relative intrinsic reliability.
   FOR YET ANOTHER EXAMPLE, the “stabilized oscillating chair” of Kelley, U.S. Pat. No. 4,254,990, features multiple spindles and bearings which will again detract from relative intrinsic reliability.
   FOR YET ANOTHER EXAMPLE, the “self-leveling and swiveling chair” of Bosnich, U.S. Pat. No. 3,863,587, still yet again exhibits a sheer, overall complexity which will detract from relative intrinsic reliability.
   FOR YET ANOTHER EXAMPLE, the “boat seat stabilizing apparatus” of Martinez et al, U.S. Pat. No. 5,119,754, features two massive cantilever-style spindles set atop massive tubular-steel gantries which will again detract from relative intrinsic reliability.
   IN CONTRAST TO the aforementioned prior art, the present invention lacks any spindles or axles. Its sliding-and-tilting-dish design broadly distributes working load on its one moving part. The design for a gimbaled chair may include dozens of parts, whereas the present invention has only one moving part and nine basic parts. The small number of parts and their artful employment substantially lessens the overall likelihood of failure.
i. COMPARING THE WHOLE INVENTION—To summarize: The present invention is completely different from and a tangible improvement upon the aforementioned gimbaled-chair devices of prior art, being:
   Substantially, tangibly simpler to make, at substantially lower cost;
   Furthermore, substantially, tangibly more compact and light yet also very strong;
   Furthermore, substantially, tangibly easier and more comfortable to use;
   Furthermore, substantially, tangibly, tangibly easier to maintain and repair;
   Furthermore, substantially, tangibly more durable;
   Furthermore, substantially, tangibly more reliable.
   Furthermore, the present invention's sliding-and-tilting dish, based on cross-braced inverted-arch technology, is completely different from the swinging-pendulum basis of gimbaled-chair devices. Their basic, underlying design precept is not far removed from the ancient mariner's hammock; the present invention takes an entirely new, different and more elegant approach to the problem. Prior related devices of art may well have worked well for their intended individual uses, but yet would be quite ill-suited for applications such as the ones for which the present invention is intended; that is, applications which in their totality specify simplicity, compact size, light weight, high strength, rugged durability and reliability.

### 2) Rolling-Chair Devices

Examples of previously patented rolling-chair devices are:
The “oscillating chair” of Thomas, U.S. Pat. No. 12,703, April 1855. (This device is a hybrid, also featuring a pitch-compensating gimbaled chair.)
The “oscillating ship's berth” of Schrader, U.S. Pat. No. 224,232, February 1880.
The “stabilizing platform” of Searing, U.S. Pat. No. 2,770,286, April 1940.
The “self-leveling seat structure” of Weller, U.S. Pat. No. 2,770,286, November 1956.
The “rolling chair frame” of Muir, III, U.S. Pat. No. 5,669,324, September 1997.
a. COMPARING RELATIVE SIMPLICITY—Rolling-chair devices in the main compensate for roll. The basic concept is that of a wheeled payload car which rolls sideways on a track frame; the frame generally consists of two parallel upward-curving rails. The wheels each will by definition have a rolling sheave, an axle, a bearing, and an axle carriage. Further adding to complexity, some means must be found to prevent the car from jumping off the tracks. The ends of the track frame will tend to form a cantilever construct which is apt to bend. Further, the track frame may have to be much wider than the chair in order for the device to achieve a meaningful degree of roll compensation. The afore-stated challenges cumulatively encourage solutions which, relative speaking, are highly engineered and intrinsically complicated. Said drawbacks exist in all rolling-chair devices of prior art.
   THEIR MOST VIVID EMBODIMENT is the “rolling chair frame” of Muir, III, U.S. Pat. No. 5,669,324, which features a wide, tubular track frame upon which a wheeled platform for a chair rolls sideways. In this design, the track is made out of square tubing. To contain the wheels from jumping off the frame, they actually ride inside the track tube; which has a slot on top to accommodate the wheels' axle carriage. Said shape would be relatively complicated to fabricate. The wheels themselves are relatively complex components, each consisting of several highly intricate parts. The practical making of this device will require metal shaping, forming and welding. The afore-stated drawbacks cumulatively endow the device with relative complexity.
   FOR ANOTHER EXAMPLE, the “self-leveling seat structure” of Weller, U.S. Pat. No. 2,770,286, features an upward-curved payload car. Said car is a highly elaborate construct of tubular members and flat plate. In this case, the rolling wheels are fixed to the support frame, not the payload car. To align and secure the payload car requires no less than 14 wheels, housed within a pair of robust brackets. Some of the wheels support the payload car from the bottom; others contain it from the top. Not only is this concept relatively complicated. It affords limited sideways travel of the payload car, and therefore only limited capacity to motion-compensate for roll. Again, the practical making of this device requires metal shaping, forming and welding. The afore-stated drawbacks cumulatively endow the device with relative complexity.
   FOR YET ANOTHER EXAMPLE, the “stabilizing platform” of Searing, U.S. Pat. No. 2,770,286, incorporates two rolling-chair devices, motion-compensating for pitch and roll. The complexity of the track frames is instructive. Also witness the elaborate system of support and containment wheels, purposed similar to those seen in the “self-leveling seat structure” of Weller. The afore-stated drawbacks yet again cumulatively endow the device with relative complexity.
   FOR YET ANOTHER EXAMPLE, the “oscillating chair” of Thomas, U.S. Pat. No. 12,703, features a sideways-extending track frame and a relatively complicated arrangement of wheels, still yet again endowing the device with relative complexity.
   FOR YET ANOTHER EXAMPLE, the “oscillating ship's berth” of Schrader, U.S. Pat. No. 224,232, features a fully supported sideways-extending track frame and a complicated arrangement of wheels, still yet again endowing the device with relative complexity.
b. COMPARING RELATIVE SIZE—Most rolling-chair devices of prior art require a relatively large installation space due to the presence of sideways-extending track frames.
   FOR EXAMPLE, the “rolling chair frame” of Muir, III, U.S. Pat. No. 5,669,324, features a wide, tubularl track frame which encroaches considerably outward to either side of the chair.
   FOR YET ANOTHER EXAMPLE, the “stabilizing platform” of Searing, U.S. Pat. No. 2,770,286, features two track frames which encroache outward to all sides of the chair.
   FOR YET ANOTHER EXAMPLE, the “oscillating chair” of Thomas, U.S. Pat. No. 12,703, features a track frame which encroaches considerably outward to either side of the chair.
   FOR YET ANOTHER EXAMPLE, the “oscillating ship's berth” of Schrader, U.S. Pat. No. 224,232, features a track frame which encroaches considerably outward to either side of the sleeping platform.
   IN CONTRAST TO the aforementioned prior art, as stated above in (1, c) IN CONTRAST TO the aforementioned prior art, the present invention fits neatly under a standard seat, no encroachment at all to the front or to the rear; the sole clearance needed will be a modest allowance to the sides to allow for the tilting of the payload platform. Compared to gimbaled-chair devices, it possesses a small footprint and can be installed in very tight spaces.
c. COMPARING RELATIVE WEIGHT—The wheels of a rolling-chair device must be strong enough to withstand high, concentrated loads, just as with the spindles on gimbaled-chair devices. The ends of the track frame will tend to form a cantilever construct which is apt to bend. Further, the track frame may have to be much wider than the chair in order for the device to achieve any meaningful degree of roll compensation. These challenges promote solutions which are highly engineered and innately heavy. The afore-stated relative drawbacks exist in all rolling-chair devices of prior art.
   FOR EXAMPLE, the “rolling chair frame” of Muir, III, U.S. Pat. No. 5,669,324, features a wide, tubular track frame upon which a wheeled platform for a chair rolls sideways. In this design, the track frame is made out of square metal tubing. Instructive here is the substantial width of the track frame, which adds to overall weight. Because the ends of the frame are cantilevered, they are required to be very heavily engineered. The practical making of this device will be almost entirely of intrinsically heavy steel tubing. The afore-stated drawbacks conspire to increase relative overall weight.
   FOR YET ANOTHER EXAMPLE, the “self-leveling seat structure” of Weller, U.S. Pat. No. 2,770,286, features an upward-curved payload car. Said car is robustly fabricated from tubular members and plate. Heavy engineering of the car is required because its cantilevered ends lack support other than that conveyed innately by the tubular material. As with the “rolling chair frame” of Muir, III, the practical making of the Weller device will be almost entirely of intrinsically heavy steel. The afore-stated drawbacks conspire again to increase relative overall weight.
   FOR YET ANOTHER EXAMPLE, the “stabilizing platform” of Searing, U.S. Pat. No. 2,770,286, incorporates two rolling-chair devices, motion-compensating for both pitch and roll. Instructive is the innate bulk of the track frames. Here they are not cantilevered, but, rather, fully supported at their ends. While this approach is strong, it also is intrinsically heavy. The afore-stated drawbacks conspire yet again to increase relative overall weight.
   FOR YET ANOTHER EXAMPLE, the “oscillating chair” of Thomas, U.S. Pat. No. 12,703, features very robust rolling wheels and a heavy, cantilevered, sideways-extending track frame. The afore-stated drawbacks conspire yet again to increase relative overall weight.
   FOR YET ANOTHER EXAMPLE, the “oscillating ship's berth” of Schrader, U.S. Pat. No. 224,232, features a fully supported sideways-extending track frame. As with the “stabilizing platform” of Searing, this construct is quite strong but also relatively heavy. The afore-stated drawbacks conspire still yet again to increase relative overall weight.
   IN CONTRAST TO the aforementioned devices of prior art, and as stated above in (1, c) the present invention features a suspension system which is intrinsically much lighter. Its sliding-and-tilting-dish mechanism remedies all of the weight drawbacks inherent to rolling-chair devices. By virtue of being based on a cross-braced inverted arch, the sliding payload car is fully supported and rigid at its ends, conquering the problem of cantilever loads while delivering weight savings. The light, compact tilting mechanism is nonetheless strong and able to motion-compensate for extreme angles of roll. Further saving weight, it eliminates all need for wheels or rollers, with their attending sheaves, axles, bearings and carriages. The sheer small size of the present invention contributes to its relative lightness. For yet further weight savings, the present invention can be readily made from lightweight composite materials.
   “Readily made” here is defined as meaning commercially practical. As stated in the Preamble, almost anything nowadays can be made out of composites. However, the cost of manufacturing increases as the complexity of the parts increases. This drives up the cost/benefit ratio, such that the product cannot be offered for sale at an attractive price. The present invention squarely addresses that problem. To facilitate cost-effective composite construction, it is designed to be built entirely and economically from flat-sheet materials, versus intricately shaped and formed tubes, which are found at the core of nearly all rolling-chair devices.
d. COMPARING RELATIVE EASE OF USE—The suspension systems of rolling-chair devices are less bothersome to the user than the suspension systems seen on gimbaled-chair devices. It is easier to get into and out of the chair, and there are fewer intrusions upon the user's upper-body freedom of movement. In this way, the general design concept is superior. Yet, most rolling-chair devices of prior art would be relatively difficult to use. Again, this is due to the presence of sideways-extending track frames. The afore-stated relative drawback exists in most rolling-chair devices of prior art.
   FOR EXAMPLE, the “rolling chair frame” of Muir, III, U.S. Pat. No. 5,669,324, features a wide, tubular track frame upon which rolls a wheeled platform for a chair. The width of this frame makes it relatively problematic for the user to access the chair from the sides.
   FOR YET ANOTHER EXAMPLE, the “stabilizing platform” of Searing, U.S. Pat. No. 2,770,286, would be difficult to enter except from the front. Once in the chair, the user would be relatively much more inconvenienced by the many awkward appendages of the device frame.
   FOR YET ANOTHER EXAMPLE, the “oscillating chair” of Thomas, U.S. Pat. No. 12,703, features a gimbaled chair, the support pedestal of which would be extremely, relatively confining to the user.
   FOR YET ANOTHER EXAMPLE, the “oscillating ship's berth” of Schrader, U.S. Pat. No. 224,232, would be mountable by a user only from the sides.
   IN CONTRAST TO the aforementioned examples of prior art, the present invention sits completely beneath the chair. With no protruding parts to the front, sides, or rear, a person can get into and out of the chair with complete ease. The person can sit down or exit from either side or from the front. Seated upon the chair, a user has complete freedom of upper-body movement.
e. COMPARING RELATIVE COMFORT—Several rolling-chair devices of prior art feature built-in, integral chairs which cannot be modified, changed or customized for the preference and comfort of individual owners.
   FOR EXAMPLE, the “stabilizing platform” of Searing, U.S. Pat. No. 2,770,286, features an integral chair, which also would be relatively much more difficult to use.
   FOR YET ANOTHER EXAMPLE, the “oscillating chair” of Thomas, U.S. Pat. No. 12,703, also features an integral chair, which also would be more relatively difficult to use.
   FOR YET ANOTHER EXAMPLE, the “oscillating ship's berth” of Schrader, U.S. Pat. No. 224,232, features an integrated sleeping platform which could be accessed only from the sides.
   IN CONTRAST TO the aforementioned examples of prior art, the present invention is a seat support. The owner will pick out and install, or have installed, his or her seat or chair of choice; dozens of different models and styles are sold. The present invention thus is readily customizable to individual taste and preference, greatly enhancing user comfort.
f. COMPARING RELATIVE EASE OF MAINTENANCE AND REPAIR—As stated in (1, e) the more complicated devices grow, the more difficult and expensive they become to repair. As stated in (2, a), the concept of rolling-chair devices promotes an overall, inherent, relative complexity. Taking apart the afore-said would be relatively far more difficult. The above-stated drawbacks exist in all rolling-chair devices of prior art.
   FOR EXAMPLE, the “rolling chair frame” of Muir, III, U.S. Pat. No. 5,669,324, features a construction which in totality is highly, relatively complicated. With its heavy tubular frame and wheeled car, the aforesaid would be very problematic to disassemble for maintenance and repair; indeed a saw might be necessary to take apart some key elements if they were to break.
   FOR YET ANOTHER EXAMPLE, the payload car of the “self-leveling seat structure” of Weller, U.S. Pat. No. 2,770,286, features a highly elaborate construct of steel tubing and flat plate. The aforesaid would be relatively quite problematic to disassemble for maintenance and repair; indeed a saw might be necessary to take apart some key elements if they were to break.
   FOR YET ANOTHER EXAMPLE, the “stabilizing platform” of Searing, U.S. Pat. No. 2,770,286, with its dual rolling mechanisms, would be relatively quite daunting to disassemble for maintenance and repair.
   FOR YET ANOTHER EXAMPLE, the “oscillating chair” of Thomas, U.S. Pat. No. 12,703, with its sideways-extending track frame buried within the mechanism of a gimbaled chair, again would be relatively quite daunting to disassemble for maintenance and repair.
   FOR YET ANOTHER EXAMPLE, the “oscillating ship's berth” of Schrader, U.S. Pat. No. 224,232, obviously was not ever envisioned to be disassembled except through demolition.
   IN CONTRAST TO the aforementioned examples of prior art, and as stated in (1, e), the critical parts of the present invention are designed to be easily taken apart. Scant likelihood exists of repair being needed. However, should such become necessary, the cassette can be easily disassembled and the end caps replaced. These parts need not be expensive because they are so simple. It would be quite practical to box up the cassette and ship it to a central service center. Furthermore, the small size of the entire unit allows the owner to readily un-install it and transport it home or to a repair shop for service.
g. COMPARING RELATIVE DURABILITY—As stated above in (1, g), the durability (working lifespan) of any manufactured thing is closely related to its complexity. As stated above in (2, a), rolling-chair devices are inherently, relatively complicated. Witness the sheer number of parts that form their individual constructs; each part is subject to wear and tear; each part therefore multiply detracts from overall durability. Furthermore, extensive use of rust-prone metals is intrinsic to rolling-chair devices of prior art.
   THEIR MOST VIVID EMBODIMENT is the “rolling chair frame” of Muir, III, U.S. Pat. No. 5,669,324, which exhibits sheer, overall, relative complexity, thus detracting from intrinsic relative durability.
   FURTHER INSTRUCTIVE is the “boat seat stabilizing apparatus” of Martinez et al, U.S. Pat. No. 12,703, which exhibits sheer, overall, relative complexity, thus again detracting from intrinsic relative durability.
   FOR YET ANOTHER EXAMPLE, the “self-leveling and swiveling chair” of Bosnich, U.S. Pat. No. 3,863,587, exhibits sheer, overall, relative complexity, thus again detracting from intrinsic relative durability.
   FOR YET ANOTHER EXAMPLE, the “pendulum helmsman seat” of Cutler, U.S. Pat. No. 4,425,863, exhibits sheer, overall, relative complexity, thus yet again detracting from intrinsic relative durability.
   FOR YET ANOTHER EXAMPLE, the “oscillating chair” of Thomas, U.S. Pat. No. 12,703, exhibits sheer, overall, relative complexity, thus yet still again detracting from intrinsic relative durability.
   FOR YET ANOTHER EXAMPLE, even the lightest and mechanically simplest of these gimbaled-chair devices, the “stabilized oscillating chair” of Kelley, U.S. Pat. No. 4,254,990, exhibits sheer, overall, relative complexity, thus yet again detracting from intrinsic relative durability.
   IN CONTRAST TO the aforementioned examples of prior art, the present invention is far more likely to last in that there simply are a lot fewer things to go wrong. With only one moving part, and nine basic total parts, there are simply fewer things to wear out. Furthermore, the unique nature of its core technology, based on a braced inverted arch, endows the present invention not just with strength, but enduring strength. Yet further, the present invention can readily be made out of corrosion-proof composite materials; which will never wear out due to rust; especially in wet environments, its unique suitability for composite construction renders the present invention extremely, relatively hardy.
h. COMPARING RELATIVE RELIABILITY—As stated in (1, h) the reliability (frequency and likelihood of breakdowns) of any manufactured thing is closely related to its complexity. As stated above in (2, a), rolling-chair devices are inherently, relatively complicated. Again, witness the sheer number of parts that form their individual constructs; each part being individually subject to wear and tear; each part therefore multiply detracting from overall durability. Furthermore, in a rolling-chair device, the weight of the chair and its occupant are borne by multiple rollers or wheels, each of which has multiple moving parts which are subject to failure. The afore-stated relative drawbacks exist in all rolling-chair devices of prior art.
   THEIR MOST VIVID EMBODIMENT is the “rolling chair frame” of Muir, III, U.S. Pat. No. 5,669,324. Said device exhibits a sheer, overall complexity which will detract from intrinsic relative reliability.
   FURTHER INSTRUCTIVE is the “boat seat stabilizing apparatus” of Martinez et al, U.S. Pat. No. 12,703. Said device exhibits a sheer, overall complexity which will again detract from intrinsic relative reliability.
   FOR YET ANOTHER EXAMPLE, the “self-leveling and swiveling chair” of Bosnich, U.S. Pat. No. 3,863,587, exhibits a sheer, overall complexity which will yet again detract from intrinsic relative reliability.
   FOR YET ANOTHER EXAMPLE, the “pendulum helmsman seat” of Cutler, U.S. Pat. No. 4,425,863, exhibits a sheer, overall complexity which will yet again detract from intrinsic relative reliability.
   FOR YET ANOTHER EXAMPLE, the “oscillating chair” of Thomas, U.S. Pat. No. 12,703, exhibits a sheer, overall complexity which still yet again will detract from relative reliability.
   FOR YET ANOTHER EXAMPLE, even the lightest and mechanically simplest of these gimbaled-chair devices, the “stabilized oscillating chair” of Kelley, U.S. Pat. No. 4,254,990, exhibits a sheer, overall complexity which will detract from intrinsic relative reliability.
   IN CONTRAST TO the aforementioned examples of prior art, the present invention lacks any wheels or rollers. Its sliding-and-tilting-dish design broadly distributes the working load on its one moving part. The design for a rolling-chair device may include dozens of parts, whereas the present invention has only one moving part and nine basic parts. The small number of parts and the artful way in which they are employed greatly lessens the relative overall likelihood of breakdowns.
i. COMPARING THE WHOLE INVENTION—To summarize: the present invention is completely different from all of the aforementioned rolling-chair devices, being:
   Substantially, tangibly simpler to make, at low cost;
   Furthermore, substantially, tangibly more compact and light yet also very strong;
   Furthermore, substantially, tangibly easier and more comfortable to use;
   Furthermore, substantially, tangibly easier to maintain and repair;
   Furthermore, substantially, tangibly more durable;
   Furthermore, substantially, tangibly more reliable.
   Furthermore, the present invention's sliding-and-tilting dish, based on cross-braced inverted-arch technology, is completely different from the basis of rolling-chair devices; that is, not being based on a track frame and a rolling payload car. The present invention takes an entirely new, different and elegant approach to the problem. Prior related devices of art may well have worked well for their intended individual uses, and yet would be quite ill-suited for applications such as the ones for which this present invention is intended; that is, applications which in their totality specify simplicity, compact size, light weight, high strength, rugged durability and reliability.

### DESCRIPTION OF FIGURES OF THE DRAWINGS

While the present invention is delineated under CLAIMS, its preferred embodiment is most fully conveyed through these drawing and the accompanying description of the features shown therein.

Drawing 1 shows a front elevational view of the fully whole invention. The BASE and PAYLOAD PLATFORM are both level in this view. The seat pictured is for contextual purposes only—not part of the claim.

Drawing 2 shows a front elevational view of the fully whole invention, with the BASE tipped 28 degrees and the PAYLOAD PLATFORM horizontal. The seat pictured is for contextual purposes only—not part of the claim.

Drawing 3 shows a side-elevational view of the fully whole invention, with the base tipped 28 degrees and the PAYLOAD PLATFORM horizontal. The seat pictured is for contextual purposes only—not part of the claim.

Drawing 4 shows a side perpendicular elevational view of the fully whole invention. The BASE and PAYLOAD PLATFORM are horizontal in this view. The seat pictured is for contextual purposes only—not part of the claim.

Drawing 5 shows a side-angle elevational view of the fully whole invention. The BASE and PAYLOAD PLATFORM are horizontal in this view. The seat pictured is for contextual purposes only—not part of the claim.

Drawing 6 shows a side-angle top view of the DISH assembled to the PAYLOAD PLATFORM.

Drawing 7 shows a side-angle top view of the CONTAINMENT CASSETTE, with its top and bottom plates and two end caps.

Drawing 8 shows a side-angle top view the SELF-LEVELING MODULE, in which the DISH is installed within the CONTAINMENT CASSETTE such that it will slide rotationally when weight is placed upon the PAYLOAD PLATFORM.

### FEATURE DESCRIPTION

The self-leveling, gravity-stabilized, sliding and tilting support for a chair has four major assembly components: the DISH, the CASSETTE, the PAYLOAD PLATFORM and the BASE.
a. The DISH is a curved laminate structure, made from solid thin-sheet layers. Said curvature describes an arc of circle. Riding in its CASSETTE, the DISH is the device's only moving part. Its laminated construction endows it with innate strength and shape-holding ability. The DISH and the PAYLOAD PLATFORM, when assembled together, acquire enormous strength, dimensional stability and durability. The aforesaid assembly also acquires high resistance to torque which would be caused by a person sitting either forward or backward in the chair. This said torque resistance prevents the dish from binding as it slides rotationally. The engineering concept is based on an inverted arch. The arch as an engineering construct dates back to the ancient Romans. It works by means of radiating forces outward. When the base of an arch is braced from spreading, by means of a cross beam which functions as a tie rod, strength increases many-fold. The PAYLOAD PLATFORM serves this engineering function by tying together the ends of the curved DISH, holding it precisely to its design radius, such that it cannot spread or flex. This allows the DISH to be made very thin and light, yet also very rigid and very strong. The DISH thus has a very high strength-to-weight ratio; such that it also can have a very small radius, yet affording motion compensation for extreme angles of roll.
b. The CONTAINMENT CASSETTE contains the curved edges of the DISH and allows it to slide rotationally. A top plate and a bottom plate imprison two end caps, holding their inward faces precisely square to each other in the horizontal and vertical planes. The end caps are made of high-density polyethylene plastic. They have a curved receptacle groove, exactly matching the radius of the DISH. The side edges of the DISH ride securely in these grooves, which are fractionally wider than the thickness of the DISH. The molecular density of the polyethylene plastic is so high that there is no wear. The material also is innately slippery, eliminating the need for lubrication; while also eliminating the need for rollers, bearings or wheels. The DISH cannot come out of the CASSETTE unless the CASSETTE is disassembled or the PAYLOAD PLATFORM removed. The need for maintenance is minimized. However, should maintenance or repair be necessary, the cassette can be easily disassembled and the end caps replaced. Furthermore, this can be done at low cost, because the end caps are very simple parts. The DISH, PAYLOAD PLATFORM and CASSETTE, when assembled together, constitute a SELF-LEVELING MODULE, upon which a chair can be mounted.
c. The PAYLOAD PLATFORM rests on top of the DISH and is designed to replaceably accept any type of chair or seat. As noted above, the PAYLOAD PLATFORM serves the dual purpose of acting as a cross brace, greatly stiffening the DISH. When the two parts are mated, the resulting construct acquires tremendous strength, rigidity and resistance to torque. The bottom of the PAYLOAD PLATFORM comes into contact with the top plate of the CASSETTE at the extreme range of tilt, acting as a stop. Accessories to the PAYLOAD PLATFORM are envisioned which would allow it serve many other needs beyond simply being a mounting surface for a seat.
d. The BASE supports the CASSETTE and PAYLOAD PLATFORM. It consists of two end plates connected by a perpendicular tie plate. “L” brackets at the foot of the end plates facilitate mounting the unit. The BASE can be built “taller or shorter.” The only fixed dimensions are those dictated by the dimensions of the CASSETTE. To motion-compensate for roll, the BASE will be installed with the self-leveling mechanism perpendicular to the longitudinal axis of the craft (athwart-ship). To motion-compensate for roll, the BASE will be installed with the self-leveling mechanism parallel to longitudinal centerline of the craft (amid-ship). Accessories are envisioned that would make it possible for the BASE to swivel on its vertical axis and also allow it to become height-adjustable. The BASE, CASSETTE and PAYLOAD PLATFORM when assembled together constitute the fully whole invention; that is, the self-leveling, gravity-stabilized, sliding and tilting support for a chair. The weight of a person sitting on the chair will cause it to tilt level to the force of gravity, even though the surface upon which the invention is mounted may tilt greatly from the horizontal.

1. A self-leveling, gravity-stabilized, sliding and tilting support for a chair, or any other type of payload, for use on moving craft of all types, the invention comprising: an upwardly curved dish; payload module; payload platform; containment cassette; self-leveling, gravity-stabilized payload module; and mounting base.

2. The dish according to claim 1, in which its curvature describes an arc of a circle.

3. The payload platform according to claim 1, comprising a simple, flat, rectangular plate.

4. The payload module as in claims 1, 2, and 3, further comprising an assembly of the dish and the payload platform and possessing the engineering properties of a cross-braced inverted arch, rendering it stiff and highly resistant to shape distortion.

5. The containment cassette according to claim 1, comprising a top plate, bottom plate and two end caps, the overall shape of this sub-assembly taking the form of a simple, open-sided box.

6. The end caps according to claim 5, comprising two blocks of low-friction plastic, each cap being fixed in place by the top plate and bottom plates of the containment cassette, thus held precisely face-parallel and face-square to each other in their vertical and horizontal planes, and each having an upwardly curved containment groove machined into its inward-facing surface, these grooves describing an arc of a circle, this circle having the exact same radius as the dish, and the grooves being fractionally wider than the thickness of the dish, and having a depth sufficient to contain the edges of the dish securely.

7. The self-leveling, gravity-stabilized payload module as in any of the preceding claims, further comprising an assembly of the payload module and the containment cassette.

8. The self-leveling, gravity-stabilized payload module according to claim 7, in which the payload module, when weight is applied to it, will slide rotationally to attain a level orientation, even though the containment cassette may tilt erratically as the craft rolls from side to side on its longitudinal axis.

9. The rotational sliding according to claim 8, in which this self-leveling method uses only one moving part and dispenses with the need for complicated, failure-prone wheels, rollers or bearings, and dispenses with gantries and gimbals, greatly reducing overall complexity of the invention and greatly enhancing its reliability.

10. The gravity-stabilized, self-leveling module according to any of the preceding claims, comprising a self-leveling mechanism which can be made very small thanks to its artful design and construction, yet able to motion-compensate for extreme angles of roll.

11. The base according to claim 1, comprising a vertically oriented front plate, a vertically oriented rear plate and a horizontally oriented tie plate, the tie plate serving to stiffen the base and prevent it from flexing and distorting in a plane perpendicular to the longitidual axis of the craft in which or upon which the invention is mounted.

12. The self-leveling, gravity-stabilized, sliding and tilting support for a chair as in any of the preceding claims, further comprising an assembly of the base and the gravity-stabilized, self-leveling module, the entire invention being easily attachable to a floor, either permanently or temporarily.

13. The self-leveling, gravity-stabilized, sliding and tilting support for a chair according to claim 12, in which the invention fits completely underneath a standard, commercially available seat or chair, with no encroachment into adjacent areas.

14. The self-leveling, gravity-stabilized, sliding and tilting support for a chair according to claim 13, in which the device can be readily made from light, strong and corrosion-proof composite materials.

15. The self-leveling, gravity-stabilized, sliding and tilting support for a chair according to claim 14, in which the term “readily made” is additionally defined as being commercially feasible from the standpoint of ease of manufacture and low cost of manufacture, such that the product can be offered for sale at a price low enough to appeal to large numbers of purchasers.

16. The self-leveling, gravity-stabilized, sliding and tilting support for a chair according to claim 15, in which the device expressly serves high-performance applications which specify, all or in part, simplicity, compact size, light weight, high strength, rugged durability and reliability, but which also is useful for any less-stringent application where the need need exists to gravity-stabilize crew, passengers and equipment.
